(19) United States
(12) Patent Application Publication
(10) Pub. No.: US 2016/0125034 A1
(43) Pub. Date: May 5, 2016

(54) Annotate Apps with Entities by Fusing Heterogeneous Signals

(71) Applicant: Google Inc., Mountain View, CA (US)

(72) Inventors: Huazhong Ning, San Jose, CA (US); Weilong Yang, Fremont, CA (US); Tianhong Fang, Mountain View, CA (US); Min-hsuan Tsai, Grapevine, TX (US); Hrishikesh Balkrishna Aradhye, Santa Clara, CA (US)

(21) Appl. No.: 14/614,688

(22) Filed: Feb. 5, 2015

Related U.S. Application Data
(60) Provisional application No. 62/073,819, filed on Oct. 31, 2014.

(51) Int. Cl. G06F 17/30

(52) U.S. Cl. CPC G06F 17/30525; G06F 17/30864; G06F 17/3089

(57) ABSTRACT

A system and method of annotating an application, including obtaining input signals associated with a target application, wherein the input signals are obtained from a plurality of sources, obtaining first annotation data from the obtained input signals, generating second annotation data in a machine-understandable form based on the first annotation data, and associating the second annotation data with the target application.

### BACKGROUND

Applications for computing devices have become popular. Systems currently exist to maintain such applications in databases which users may search and browse when looking for new, entertaining or useful applications for their devices. Meta data associated with apps in such systems helps to facilitate application search and discovery.

### BRIEF SUMMARY

According to an embodiment of the disclosed subject matter, a computer-implemented method may include obtaining, using at least one processing circuit, input signals associated with a target application, wherein the input signals are obtained from a plurality of sources, obtaining, using at least one processing circuit, first annotation data from the obtained input signals, generating second annotation data in a machine-understandable form based on the temporary annotation data, and associating the second annotation data with the target application.

According to an embodiment of the disclosed subject matter, a system may include a storage device, a memory that stores computer executable components, and a processor that executes computer executable components stored in the memory, including a document annotation component to receive a first input signal of meta data associated with a target application and a second input signal of web-based documents which mention the target application, and to generate first annotation data by mapping phrases of the web-based document and phrases of the target application meta data to predetermined entities, a query annotation component to receive a third input signal of queries which have triggered downloads of the target application and to generate first annotation data by mapping phrases from the queries to predetermined entities, a smear annotation component to receive a fourth input signal of existing annotations from secondary applications which are co-clicked pairs with the target application and to generate first annotation data based on the existing annotations, an input component to receive a human evaluation of samples of the first annotation data, and a fusion component to generate second annotation data based on the first annotation data by weighting the first, second, third and fourth input signals based on the human evaluation, and to associate the second annotation data with the target application.

Furthermore, according to an embodiment of the disclosed subject matter, means for obtaining input signals associated with a target application, wherein the input signals are obtained from a plurality of sources, obtaining first annotation data from the obtained input signals, generating second annotation data in a machine-understandable form based on the temporary annotation data, and associating the second annotation data with the target application, are provided.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an exemplary network environment configuration according to an embodiment of the disclosed subject matter.

FIG. 2 shows an exemplary annotation system according to an embodiment of the disclosed subject matter.

FIG. 3 shows a flowchart of annotating a target app according to an embodiment of the disclosed subject matter.

FIG. 4 shows a computing device according to an embodiment of the disclosed subject matter.

FIG. 5 shows a network configuration according to an embodiment of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure may be practiced without these specific details, or with other methods, components, materials, etc. In other instances, well-known structures and devices are shown in block diagram form to facilitate describing the subject disclosure.

In a conventional system for managing applications for computing devices, for example, downloadable “apps” for smartphone and mobile computing devices, the apps include meta data which is typically noisy, messy, and not machine-understandable. As such, the meta data is normally not easy to use for the purpose of improving the quality of app search and discovery within the system.

The subject matter disclosed herein provides a system and method to generate annotation data and annotate apps with clean and machine-understandable entities. These entities can be associated with apps as annotation data and be used to improve search and discovery functions for content item systems such as online app stores, web-based music stores, etc. Furthermore, the system can include features to improve the accuracy of the generated annotation data over time and provide useful statistical data, thereby improving the efficiency of the system and, in the case of implementation in online store-type systems, increasing the revenue thereof.

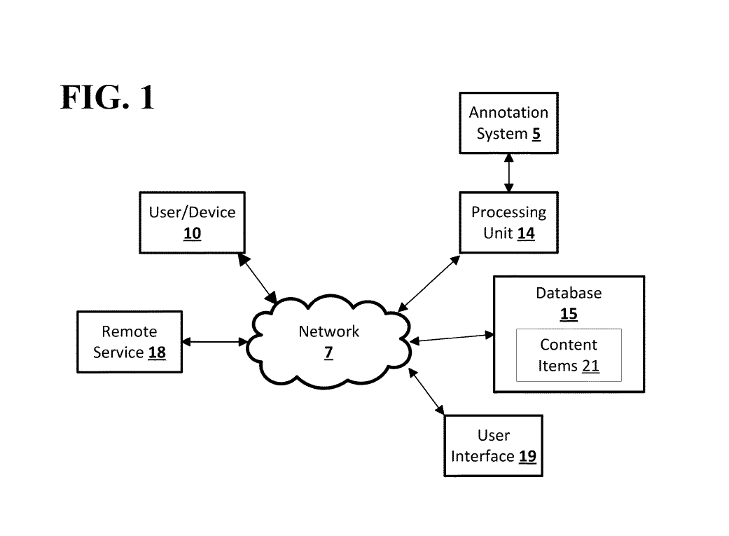

FIG. 1 shows an example environment arrangement according to an embodiment of the disclosed subject matter. One or more devices or systems/user devices 10 such as local computers, smart phones, tablet computing devices, remote services/service providers 18, and the like, may connect to other devices via one or more networks 7. The network 7 may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 19. In some cases, the devices 10, 11 may communicate with a user-facing interface system 19, which may provide access to one or more other systems such as a database 15, a processing unit 14, or the like. For example, the user interface 13 may be a user-accessible web page that provides data from one or more other computer systems. The user interface 19 may provide different interfaces to different clients, such as where a human-readable web page is provided to a web browser client on a user device 10, and a computer-readable API or other interface is provided to a remote service client 11.

The database 15 may include a plurality of content items 21. Content items 21 may include, for example and without limitation, applications (“apps”) for computing devices, video data files, music data files, digital picture files, games, or other types of content which may be browsed, searched and downloaded by users. Hereinafter, for illustrative purposes the database will be described as storing content items 21 as apps available for sale or free download to users of the system disclosed. However, one of ordinary skill in the art will understand that this designation is solely for convenience of description and not in any way limiting of the general inventive concept provided herein.

The user interface 19, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with database 15 and/or user interface 13.

An annotation system 5 may provide back-end processing. Stored or acquired data, e.g., data associated with apps, may be pre-processed by the annotation system 5 before delivery to the processing unit 14, database 15, and/or user interface 19. For example, as will be described further below, annotation system 5 may include a machine learning system and provide various prediction models, data analysis, or the like to one or more other systems 19, 14, 15, as well as analyze and generate annotation data for apps stored in database 15.

As indicated above, a plurality of apps may be stored in database 15, or in another suitable storage device accessible to annotation system 5. For any target app, annotation system 5 may obtain input signals via network 7 from a plurality of sources, generate potential annotation data from the input signals, and “fuse” the potential annotations to generate final annotation data. Herein, annotation data may be defined as informational data which is descriptive of some aspect of a target app and which is associated with the target app. Such association may be executed, for example, without limitation, by tagging, linking, direct or indirect reference, or integral inclusion in the app data. To annotate a target app therefore refers to associating annotation data with the target app.

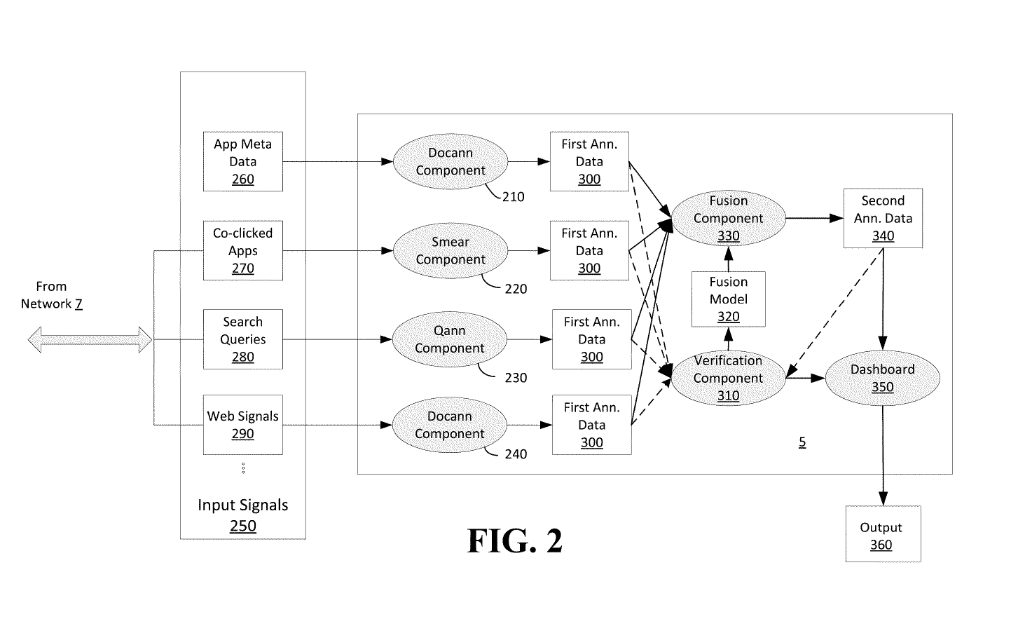

FIG. 2 provides a conceptual diagram of an exemplary annotation system 5 which may be used to annotate apps 21 in accordance with an embodiment of the present disclosure. Annotation system 5 may include one or more components which a person of ordinary skill in the art would appreciate may be implemented using software and/or electrical circuit(s) that can include circuitry elements of suitable function in order to implement the embodiments described herein. Such components include one or more document annotation (Docann) components 210, a smear component 220, a query annotation (Qann) component 230, a processing component 240, and a tagging component 250. Furthermore, one of ordinary skill in the art can appreciate that many of these various components can be implemented on one or more integrated circuit (IC) chips.

Referring to FIGS. 1-2, annotation system 5 may obtain input signals 250 regarding a target app. The input signals 250 may be obtained from a plurality of sources, for example, via network 7. The exact input signals obtained will depend on the availability of data and may vary from the embodiment illustrated in FIG. 2. In this example, four input signals are obtained, but more or less input signals and of different sources may be obtained within the scope of the present general inventive concept.

An exemplary input signal is app meta data 260. App meta data 260 may be obtained from the target app itself. App meta data 260 may include, for example, title, description, category, etc. The document annotation component 210 may map phrases (tokens) obtained from the app meta data 260 to one or more entities and generate the one or more entities as first annotation data 300. Herein, an entity is a thing or concept which exists in the world and which is represented by a unique ID. An entity ID may be independent of language restrictions or categorical limitations. For example, using the established Freebase entity system, a social networking app could be tagged with “entity:/m/01w362” (social network) and/or “entity:/m/0fj7z” (instant messaging), etc.

Another exemplary input signal is co-clicked application data 270. A two or more apps may be defined as co-clicked apps when they are selected from the same search query by the same or different users. Co-clicked application data 270 may be therefore defined as the data associated with applications that are co-clicked with the target application. The value of co-clicked application data is based on the proposition that a user may click similar apps during a single search. For example, a user may search database 15 for apps using the query “shooter game.” Based on that single query, the user may select and view a plurality of apps, including the target app.

Co-clicked application data 270 of a plurality of apps in database 15 may be generated by aggregating a plurality of users' search and selection statistics. Smear component 220 may obtain co-clicked application data 270 of the target application and propagate existing entity annotations of the co-clicked apps to generate first annotation data 300. For examples, smear component 220 may utilize a majority voting process to determine which entity annotations are propagated as first annotation data 300 for the target application.

The user search queries themselves may be used as an additional exemplary input signal. In other words, search queries 280 that result in a download/selection/purchase of the target app may be a valuable input signal. The query annotation component 230 may obtain search query 280 input signals and map the query phrases (tokens) to defined entities. In this sense, the query annotation component 230 may function similar to the document annotation component 210, however, being more customized to process a search query 280 input signal.

Similarly, web documents that mention the target app can provide another exemplary input signal. Web signals 290 may be obtained by a document annotation component 240 to generation additional first annotation data 300 for the target application. For example, a web page titled “The Best Education Apps” may include mention of the target app. By mapping phrases from the page to defined entities, the document annotation component may generate first annotation data 300 for the target application.

A fusion component 330 receives the first annotation data 300 obtained from the plurality of input signals 250. According to a fusion model 320, the fusion component may generate second annotation data 340 based on the collectively received first annotation data 300.

Any of several fusion models 320 may be used by the fusion component 330. For example, fusion model 320 may assign ranking to entity data based on a majority voting algorithm. In another embodiment, fusion model 320 may assign weighting to input signals 250 based on the source in a linear model. In the linear model, an entity may be appear as first annotation data 300 generated from more than one source. The final weight of the entity is a linear compilation of the weights assigned to the respective input signals 250. For example, web signals 290 may be assigned a weight of 0.2 while co-clicked application data 270 may be assigned a weight of 0.7. An entity generated as first application data 300 from both of web signals 290 and co-clicked application data 270 may therefore be given a weight of 0.2+0.7=0.9 according to fusion model 320.

Based on the fusion model 320 and the first annotation data 300, the fusion component 330 may generate second annotation data 340 to be outputted and associated with the target app. The second annotation data 340 may be entities which are machine-understandable, thereby increasing the translatability and usefulness of the generated annotations.

Annotation system 5 may further implement a machine-learning function by utilizing a verification component 310. The verification component 310 may receive a sampling of the first annotation data 300 and the second annotation data 340, indicated by the dashed lines in FIG. 2. Based on the samplings, the verification component 310 may adjust the fusion model 320. For example, in one embodiment the verification component 310 may use human evaluation of the sampled data. The human evaluation may be used to assess and/or rate the accuracy of the fusion model 320 weighting designations and the accuracy of the final annotation entities as represented by second annotation data 340. Thereby the annotation system 5 may “learn” and constantly improve in accuracy of results.

The second annotation data 340 may also be provided to a dashboard component 350 prior to being output to be associated with the target app. The dashboard component 350 may compute statistics/metrics to monitor the progress of the annotation system 5. For example, the dashboard component may compute comparative data based on the human evaluations used as verification data and the second annotation data 340. Exemplary data the dashboard component may provide include but are not limited to precision, recall, coverage, difference, and other statistical data.

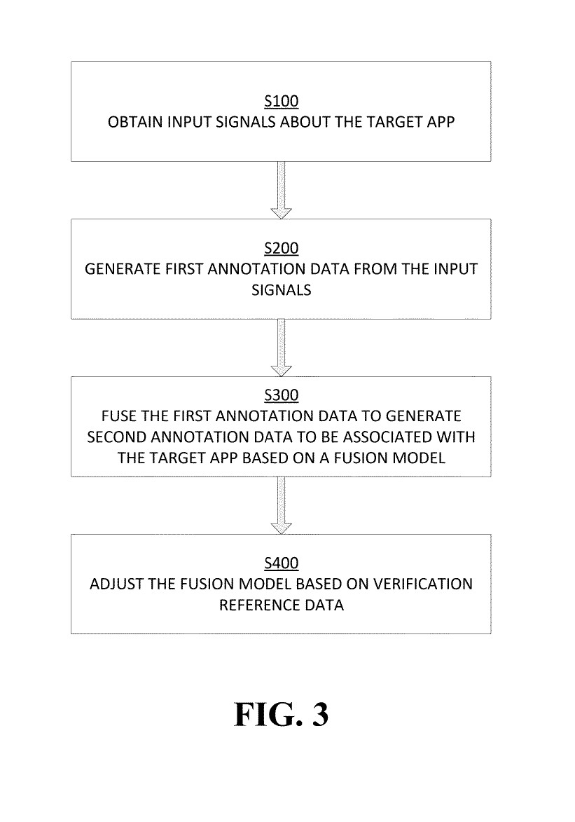

The annotation system 5 may accordingly annotate a target application as illustrated in the flowchart of FIG. 3. At operation S100, the system 5 obtains input signals about the target application. The input signals may be obtained from a plurality of sources. At operation S200 the system 5 generates first annotation data from the input signals.

At operation S300 the system fuses the first annotation data to generate second annotation data. The fusing may comprise ordering, ranking or selecting annotations from the first annotation data and discarding others. The second annotation is generated in a form that is machine-understandable. In some instances, this may require translation or conversion of data from one form to another. The second annotation data is fused from the first annotation data based on a fusion model. Once the second annotation data been generated in machine-understandable form, it is associated with the target app.

At operation S400, the system 5 adjusts the fusion model based on verification reference data. The system may acquire the verification reference data by human evaluation of the first and second annotation data. For example, human evaluation may be used to rate the accuracy of the first and second annotation data in view of the target application.

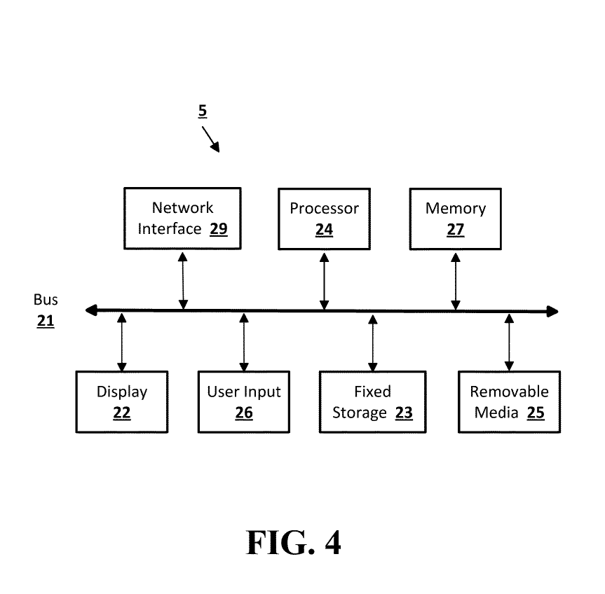

The system 5 may utilize the document annotation component 210, smear component 220, query annotation component 230, fusion component 330 and verification component 310 as described above to execute the operations of FIG. 3. These and other components may be implemented using one or more individual processing circuits or collectively implemented using an integrated processing circuit. Alternatively, these components may be implemented using software components stored in a storage of a computing device and executed by a memory and a processor. FIG. 4 is an example computing device 20 suitable for implementing annotation system 5 in embodiments of the presently disclosed subject matter.

Referring to FIG. 4, the device 20 may be, for example, a server, desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

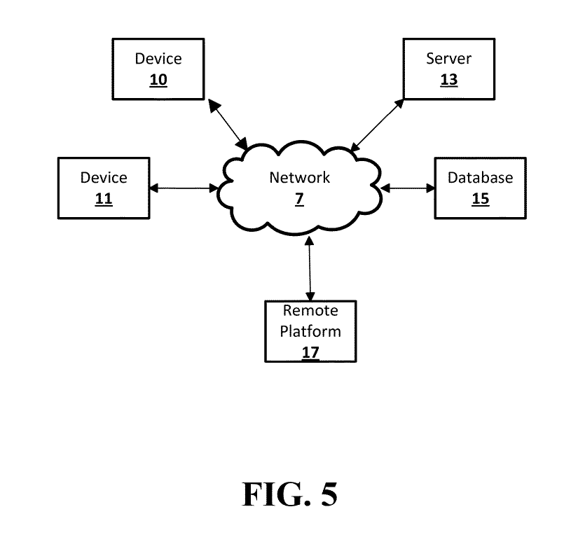

FIG. 5 shows another example network arrangement according to an embodiment of the disclosed subject matter. One or more devices 10, 11, such as local computers, smart phones, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a system as disclosed herein.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method, comprising:
obtaining, using at least one processing circuit, input signals associated with a target application, wherein the input signals are obtained from a plurality of sources;
generating first annotation data from the input signals;
generating second annotation data in a machine-understandable form based on the first annotation data and a fusion model; and
associating the second annotation data with the target application.

2. The method of claim 1, further comprising:
obtaining verification reference data of the first annotation data and the second annotation data; and
adjusting the fusion model based on the verification reference data.

3. The method of claim 2, wherein the plurality of input signals includes signal data representing one or more secondary applications which have been co-clicked with the target application.

4. The method of claim 3, further comprising generating at least a portion of the first annotation data by propagating existing annotations from the one or more secondary applications.

5. The method of claim 2, wherein the input signals include signal data representing search queries which have triggered downloads of the target application, web-based documents that include mentions of the target application, and meta data of the target application.

6. The method of claim 5, further comprising:
mapping text phrases of the search queries, meta data, and web-based documents to entities; and
generating at least a portion of the first annotation data based on the entities.

7. The method of claim 6, wherein the verification reference data is obtained via human evaluation of a sampling of the first annotation data and the second annotation data.

8. The method of claim 7, wherein the fusion model weights the input signals based on the human evaluations, and
wherein generating the second annotation data further comprises applying a linear weighting model to the first annotation data according to the fusion model weighting of the input signals.

9. The method of claim 7, further comprising:
computing statistical comparison data based on the human evaluations and the second annotation data; and
providing the statistical comparison data in an interface to monitor the second annotation data.

10. The method of claim 9, wherein the statistical comparison data includes at least one of precision, recall, coverage, or difference.

11. A system, comprising: a storage device; a memory that stores computer executable components; and a processor that executes the following computer executable components stored in the memory:
a document annotation component to receive a first input signal representing meta data associated with a target application and a second input signal representing web-based documents which mention the target application, and to generate first annotation data by mapping phrases of the web-based document and phrases of the target application meta data to predetermined entities;
a query annotation component to receive a third input signal representing queries which have triggered downloads of the target application and to generate first annotation data by mapping phrases from the queries to predetermined entities;
a smear annotation component to receive a fourth input signal representing existing annotations from secondary applications which are co-clicked pairs with the target application and to generate first annotation data based on the existing annotations;
an verification component to receive a human evaluation of samples of the first annotation data and the second annotation data; and
a fusion component to generate second annotation data based on the first annotation data by weighting the first, second, third and fourth input signals based on the human evaluation, and to associate the second annotation data with the target application.

12. A system, comprising: a storage device; a memory that stores computer executable components; and a processor that executes the following computer executable components stored in the memory:
one or more input signal components to obtain input signals associated with a target application, wherein the input signals are obtained from a plurality of sources;
an annotation component to generate first annotation data from the input signals;
a fusing component to generate second annotation data based on the first annotation data by applying a weighting value to one or more of the plurality of sources based on a fusion model, and to associate the second annotation data with the target application; and
a verification component to obtain verification reference data regarding the first annotation data and the second annotation data and to adjust the fusion model based on the verification reference data.

13. The system of claim 12, wherein the verification component obtains the verification reference data based on a human evaluation of a sampling of the first annotation data and the second annotation data.

14. The system of claim 13, wherein the input signals include data representing one or more secondary applications which have been co-clicked with the target application.

15. The system of claim 14, wherein the annotation component generates the first annotation data by propagating existing annotation data from the one or more secondary applications.

16. The system of claim 13, wherein the input signals include search queries which have triggered downloads of the target application, web-based documents that include mentions of the target application, and meta data of the target application.

17. The system of claim 16, wherein the annotation component maps text phrases of the search queries, web-based documents, and meta data to entities and generates the second annotation data based on the entities.

18. The system of claim 13, wherein the verification component weights the input signals based on the human evaluations, and
wherein the annotation component generates the second annotation data from the first annotation data by applying a linear model to the weighted input signals.

19. The system of claim 13, further comprising an output unit to compute statistical comparison data based on the human evaluations and the second annotation data, and provide the statistical comparison data in an interface.

20. The system of claim 19, wherein the statistical comparison data includes at least one of precision, recall, coverage, or difference.
